(19) United States
(12) Patent Application Publication
(10) Pub. No.: US 2025/0219758 A1
(43) Pub. Date: Jul. 3, 2025

(54) SIGNALING OF MODULATION AND/OR CODING IN A WIRELESS COMMUNICATIONS SYSTEM

(71) Applicant: NXP USA, Inc., AUSTIN, TX (US)

(72) Inventors: Rui Cao, Sunnyvale, CA (US); Rong Zhang, San Jose, CA (US); Amer Al-Baidhani, Santa Clara, CA (US); Hongyuan Zhang, Fremont, CA (US); Liwen Chu, San Ramon, CA (US)

(21) Appl. No.: 19/002,105

(22) Filed: Dec. 26, 2024

Related U.S. Application Data
(60) Provisional application No. 63/707,950, filed on Oct. 16, 2024.
(60) Provisional application No. 63/688,167, filed on Aug. 28, 2024.
(60) Provisional application No. 63/667,063, filed on Jul. 2, 2024.
(60) Provisional application No. 63/567,379, filed on Mar. 19, 2024.
(60) Provisional application No. 63/617,275, filed on Jan. 3, 2024.

(51) Int. Cl. H04L 1/00

(52) U.S. Cl. CPC H04L 1/0003

(57) ABSTRACT

Embodiments of a wireless device and method are disclosed. In an embodiment, a wireless device comprises a wireless transceiver to receive and transmit frames, and a controller operably coupled to the wireless transceiver to process the frames, wherein the controller is configured to generate a frame that includes an indication selected from a first indication of an unequal modulation and/or coding and a second indication of equal modulation and/or coding.

### CROSS-REFERENCE TO RELATED APPLICATIONS

This application is entitled to the benefit of U.S. Provisional Patent Application Ser. No. 63/707,950, filed on Oct. 16, 2024, U.S. Provisional Patent Application Ser. No. 63/688,187, filed on Aug. 28, 2024, U.S. Provisional Patent Application Ser. No. 63/667,063, filed on Jul. 2, 2024, U.S. Provisional Patent Application Ser. No. 63/567,379, filed on Mar. 19, 2024, and U.S. Provisional Patent Application Ser. No. 63/617,275, filed on Jan. 3, 2024, which are all incorporated herein by reference.

### BACKGROUND

Wireless communications devices, e.g., access points (APs) or non-AP devices, can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey communications signaling information, for example, information related to data, communications links, and/or multi-link devices (e.g., operation and/or capability parameters of multi-link devices) within the wireless communications system.

### SUMMARY

Embodiments of a wireless device and method are disclosed. In an embodiment, a wireless device comprises a wireless transceiver to receive and transmit frames, and a controller operably coupled to the wireless transceiver to process the frames, wherein the controller is configured to generate a frame that includes an indication selected from a first indication of an unequal modulation and/or coding and a second indication of equal modulation and/or coding.

In an embodiment, the controller is configured to generate the frame that includes a 1-bit unequal modulation subfield in a user info field of the frame.

In an embodiment, the controller is configured to generate the frame, wherein an unequal modulation subfield of the frame indicates when an unequal modulation is used and a corresponding unequal modulation pattern is indicated in a modulation pattern subfield of the frame.

In an embodiment, the controller is configured to generate the frame, wherein a beamforming bit and a coding bit are used to indicate an unequal modulation pattern when an unequal modulation is used.

In an embodiment, the controller is configured to generate the frame, wherein a beamforming bit and a bit from a number of spatial streams subfield are used to indicate an unequal modulation pattern.

In an embodiment, the controller is configured to generate the frame, wherein an indication of the unequal modulation pattern is dependent on the total number of spatial streams.

In an embodiment, the controller is configured to generate the frame, wherein the unequal modulation pattern indicates a modulation order difference of each spatial stream from a first spatial stream.

In an embodiment, the controller is configured to generate the frame that includes a 5-bit Modulation and Coding Scheme (MCS) subfield that signals all MCS options for all spatial streams when the equal modulation is indicated and for a first spatial stream when the unequal modulation is indicated.

In an embodiment, the controller is configured to generate the frame that separately signals the unequal modulation and/or coding and the equal modulation and/or coding.

In an embodiment, the controller is configured to generate the frame that includes an N-bit subfield that signals a pattern selected from a plurality of patterns, wherein the patterns include a particular pattern that indicates an equal Modulation and Coding Scheme (MCS) and differential modulation and/or MCS unequal modulation patterns.

In an embodiment, the controller is configured to generate the frame that includes an unequal modulation subfield that indicates when an unequal modulation and/or an unequal Modulation and Coding Scheme (MCS) is used and an MCS subfield that indicates a pattern for a particular number of spatial streams.

In an embodiment, the controller is configured to generate the frame that jointly signals the unequal modulation and/or coding and the equal modulation and/or coding.

In an embodiment, the controller is configured to generate the frame that includes a 5-bit Modulation and Coding Scheme (MCS) subfield, wherein a bit in the MCS subfield indicates when an equal modulation or an unequal modulation and/or MCS is used, and wherein four bits of the MCS subfield indicate a pattern from a plurality of equal modulation, unequal modulation and/or unequal MCS patterns.

In an embodiment, the controller is configured to generate the frame that includes (4+N) bits that indicate an equal modulation pattern and an unequal modulation and/or unequal MCS pattern, wherein N is a positive integer and wherein the unequal modulation and/or unequal MCS pattern corresponds to a particular number of spatial streams.

In an embodiment, the controller is configured to generate the frame that includes (4+N) bits that indicate an equal modulation pattern, an unequal modulation and/or unequal MCS pattern and a number of spatial streams, wherein N is a positive integer.

In an embodiment, the controller is configured to generate the frame, wherein a coding bit in the bit is repurposed to indicate an unequal modulation pattern over a frequency domain.

In an embodiment, a method of transmitting a frame in a communications system comprises generating, at a first wireless device of the communications system, a frame that includes an indication selected from a first indication of unequal modulation and/or coding and a second indication of equal modulation and/or coding, and transmitting, from the first wireless device, the frame to a second wireless device of the communications system.

In an embodiment, the frame includes a 1-bit unequal modulation subfield in a user info field of the frame.

In an embodiment, an unequal modulation subfield of the frame indicates when an unequal modulation is used and a corresponding unequal modulation pattern is indicated in a modulation pattern subfield of the frame.

In an embodiment, a wireless device comprises a wireless transceiver to receive and transmit frames, and a controller operably coupled to the wireless transceiver to process the frames, wherein the controller is configured to generate a frame that includes an indication selected from a first indication of an unequal modulation and/or coding and a second indication of equal modulation and/or coding and wherein the frame includes a 5-bit Modulation and Coding Scheme (MCS) subfield and an N-bit unequal modulation subfield that signals a pattern of modulation or MCS difference relative to a base MCS.

Other aspects in accordance with the invention will become apparent from the following detailed description, taken in conjunction with the accompanying drawings, illustrated by way of example of the principles of the invention.

### BRIEF DESCRIPTION OF DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 shows an example of a modified user info field for a non-Multi-User Multiple-Input, Multiple-Output (non-MUMIMO) allocation in accordance with an embodiment of the invention.

FIG. 5 shows an example of a modified user info field for a non-MUMIMO allocation in accordance with another embodiment of the invention.

FIG. 6 shows an example of a modified user info field for a non-MUMIMO allocation, where a Modulation and Coding Scheme (MCS) subfield is expanded by one (1) bit and N bits (2 or 3) are added to a number of spatial streams (Nss) field to indicate unequal modulation (UEQM) differential patterns in accordance with an embodiment of the invention.

FIG. 7 shows an example of a modified user info field, where a single bit UEQM subfield indicates different interpretation of the Nss subfield, in accordance with an embodiment of the invention.

FIG. 8 shows an example of a modified user info field, where a single bit UEQM subfield indicates different interpretation of beamforming coding subfields, in accordance with an embodiment of the invention.

FIG. 9 shows an example of a modified user info field, where the Nss subfield is limited to two (2) bits for single user, in accordance with an embodiment of the invention.

FIGS. 10A and 10B show examples of a modified user info field, wherein one UEQM bit indicates either beamforming and coding or a UEQM pattern in accordance with embodiments of the invention.

FIGS. 11A and 11B show examples of a modified user info field, wherein one UEQM bit indicates either beamforming and the most significant bit of Nss or a UEQM pattern in accordance with embodiments of the invention.

FIGS. 12A and 12B show examples of a common info field, wherein frequency domain (FD) UEQM is indicated, in accordance with embodiments of the invention.

FIG. 13 shows an example of a modified user info field, where a single bit UEQM subfield indicates different interpretation of beamforming and coding subfields, in accordance with an embodiment of the invention.

FIGS. 14A and 14B show examples of a user info field, wherein frequency domain (FD) UEQM is indicated, in accordance with embodiments of the invention.

FIG. 15 shows a user info field for a MU-MIMO allocation in accordance with an embodiment of the invention.

FIGS. 16A and 16B show examples of a user info field, wherein one bit is added for 2×1944 indication, in accordance with embodiments of the invention.

FIGS. 17A and 17B show examples of a new trigger frame in accordance with embodiments of the invention.

FIG. 18 illustrates a flow diagram of a method of transmitting a frame in a communications system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

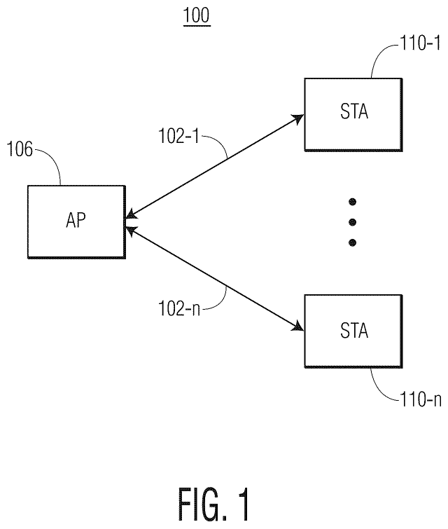

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n with n being an integer may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

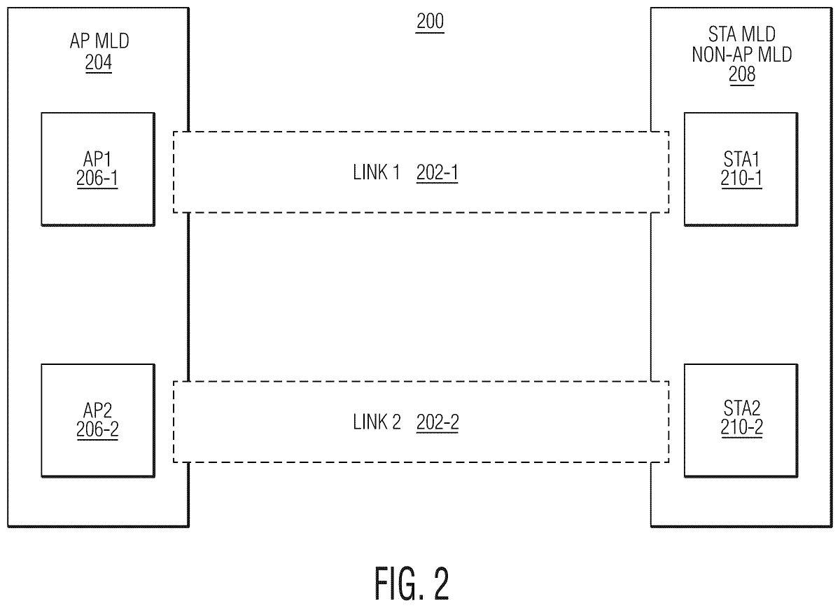

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHZ BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames other than Beacon, Data frames, control frames etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

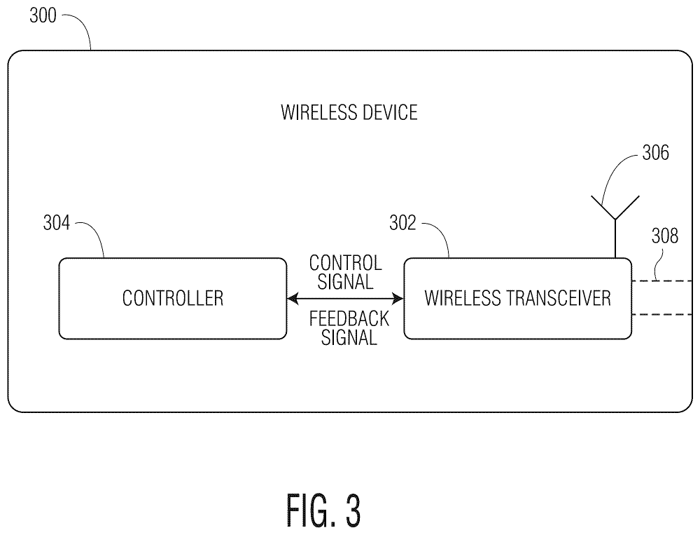

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In order to improve rate-versus-range performance, new Modulation and Coding Scheme (MCS) definitions may be introduced in 802.11bn (UHR). In a first scheme, unequal modulation or unequal MCS across spatial streams or resource units (RU) is defined. In this first scheme, each number of spatial streams (Nss) may have the same or different modulation or MCS (modulation/MCS) and/or each RU may have the same or different modulation/MCS. In a second scheme, new equal MCSs are defined. In this second scheme, in addition to existing sixteen (16) MCS choices, additional N MCSs with new quadrature and coding (QAM+coding) combinations are added, for example, 16 QAM+2/3 rate, 256 QAM+2/3 rate.

In an embodiment, to support the new MCS definitions, two MCS signaling methods are used. In the first method, expanded equal MCS signaling, plus additional unequal modulation/MCS signaling are used. In the second method, mixing of equal MCS and unequal modulation/MCS signaling is used. These two methods will be described in detail below.

In the first method, existing four (4) bits of an MCS subfield (e.g., in an EHT Multi-User (MU) PPDU) are expanded to five (5) bits to signal additional new equal MCSs. It is noted here that four (4) bits are sufficient if there is no new equal MCS defined. In an embodiment, unequal modulation (UEQM) signaling across spatial domain may be used. In this embodiment, the same MCS field can indicate a base MCS for multi-stream case, e.g., the MCS of 1st stream/RU. In a first option, N bits are used to indicate the pattern of modulation/MCS difference relative to the base MCS. For example, N can be three to four (3˜4). The N bits may signal equal modulation (EQM) Nss and UEQM together. In a second option, one (1) bit is used to indicate EQM or UEQM (EQM/UEQM) plus K bits are used to indicate UEQM patterns. As an example, the MCS field may be repurposed to indicate UEQM QAM combinations if UEQM is indicated. As another example, the Nss field may be repurposed to indicate UEQM QAM patterns if UEQM is indicated.

The first option of the first method is further described using a first example. In this example, N=2 or 3, which can indicate four or eight differential patterns. In this example, the MCS field indicates the MCS (M) of 1st stream/RU, and 2 bits indicate the pattern of modulation/MCS difference relative to the base MCS, e.g., Equal MCS; Unequal pattern 0; Unequal pattern 1; Unequal pattern 2; . . . ; Unequal pattern 7. Below is an example of 2-bit table of differential patterns.

| | Nss = 2 | Nss = 3 | Nss = 4 |
|---|---|---|---|
| 00 | EQM | EQM | EQM |
| 01 | [M, M-1] | [M, M, M-1] | [M, M, M-1, M-1] |
| 10 | [M, M-2] | [M, M, M-2] | [M, M, M-1, M-2] |
| 11 | Reserved | [M, M-1, M-2] | [M, M-1, M-2, M-2] |

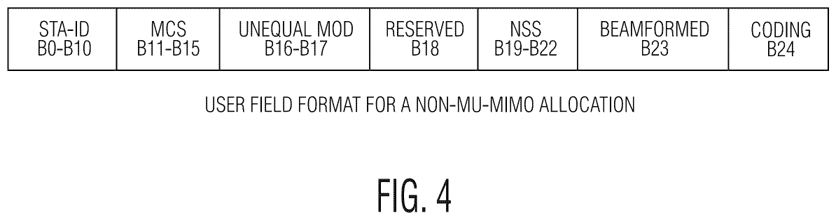

An example of a modified user info field for a non-Multi-User Multiple-Input, Multiple-Output (non-MUMIMO) allocation in accordance with an embodiment of the invention is illustrated in FIG. 4. Similar to a user field format of an EHT MU PPDU, the modified user info field includes a station identification (ID) subfield, an MCS subfield, a reserved subfield, an Nss subfield, a beamformed (or beamforming) subfield and a coding subfield. However, as shown in FIG. 4, the MCS subfield of the modified user info field has been increased by one (1) additional bit (B15), and a new 2-bit unequal modulation subfield has been added (B16-B17).

The first option of the first method is further described using a second example. In this example, N=2, which can indicate four differential patterns. In this example, bit 1 indicates how many different modulation orders there are among all Nss, which include one modulation order (EQM) or two modulation orders (UEQM). Bit 2 indicates the modulation difference of the 2^{nd} modulation relative to the first modulation if UEQM is indicated, which may be either one (1) order lower or two (2) order lower.

The second option of the first method is further described using the following two examples. In the first example, the 5-bit MCS subfield indicates a new 32-entry UEQM table for each Nss. In the second example, the 5-bit MCS subfield is partitioned into two subfields. The first subfield of the MCS subfield, which may include one (1) or two (2) bits, is used to signal the QAM pattern for each Nss, which is illustrated in the following table.

| | 2 Group Table A | 3 Group Table B |
|---|---|---|
| 2Nss | [M1, M2, CR] | |
| 3Nss | [M1&2, M3, CR] | [M1, M2, M3, CR] |
| | [M1, M2&3, CR] | |
| 4Nss | [M1&2, M3&4, CR] | [M1&2, M3, M4, CR] |
| | [M1, M2&3&4, CR] | [M1, M2, M3&4, CR] |
| | [M1&2&3, M4, CR] | [M1, M2&3, M4, CR] |

The second subfield of the MCS subfield, which includes three to four (3˜4) bits, is used to signal the QAM combinations for each QAM pattern, which is illustrated in the following tables.

| | [G1, G2, G3, CR] | [G1, G2, G3, CR] | [G1, G2, G3, CR] |
|---|---|---|---|
| 3 Group | [256, 64, 16, ⅔] | [1024, 256, 64, ⅔] | [4096, 1024, 256, ⅔] |
| Table B | | | |
| | [256, 64, 16, ¾] | [1024, 256, 64, ¾] | [4096, 1024, 256, ¾] |
| | | | [4096, 1024, 256, ⅚] |

| | [G1, G2, CR] | [G1, G2, CR] | [G1, G2, CR] | [G1, G2, CR] |
|---|---|---|---|---|
| 2 Group | [64, 16, ⅔] | [256, 64, ⅔] | [1024, 256, ⅔] | [4096, 1024, ⅔] |
| Table A | | | | |
| | [64, 16, ¾] | [256, 64, ¾] | [1024, 256, ¾] | [4096, 1024, ⅚] |
| | [256, 16, ⅔] | [1024, 64, ⅔] | [1024, 256, ⅚] | |
| | [256, 16, ¾] | [1024, 64, ¾] | [4096, 256, ⅔] | |
| | | | [4096, 256, ¾] | |
| | | | [4096, 256, ⅚] | |

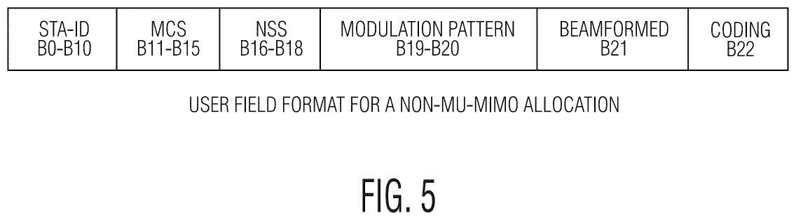

The first option of the first method using a 23-25 bit user info field is further described using two examples. In the first example, the MCS subfield is expanded by one (1) bit and N bits (2 or 3) are added to indicate UEQM differential patterns. A 25-bit user field format with the expanded MCS field and two (2) bits added in accordance with an embodiment of the invention was shown in FIG. 4. In an embodiment, the reserved bit may be skipped or removed to make the total bit count to be twenty-four (24). In addition, the Nss subfield may be shrunk or reduced to three (3) bits to make the total bit count to be twenty-three (23) for the user info field, as illustrated in FIG. 5. In this figure, the unequal modulation subfield has been replaced with a modulation pattern subfield.

In an embodiment, the 25-bit user field format shown in FIG. 4 can be used to indicate Frequency Domain (FD) UEQM. In this embodiment, the MCS subfield indicates the MCS (M) of the primary RU, and two (2) added bits indicate the pattern of modulation/MCS difference relative to the base MCS, i.e., Equal MCS; Unequal pattern 0; Unequal pattern 1; Unequal pattern 2; . . . ; Unequal pattern 7. Below is one example of a 2-bit table assuming two RUs.

| | QAM pattern between |
|---|---|
| | RUs |
| 00 | EQM |
| 01 | [M, M-1] |
| 10 | [M, M-2] |
| 11 | Reserved |

In an embodiment, the reserved bit may be skipped or removed to make the total bit count to be twenty-four (24). In addition, the Nss subfield may be shrunk or reduced to three (3) bits to make the total bit count to be twenty-three (23) for the user info field, as illustrated in FIG. 5.

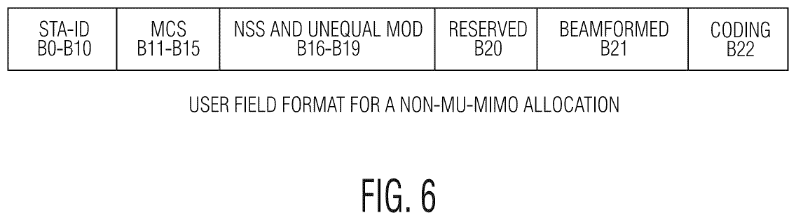

In the second example, the MCS subfield is expanded by one (1) bit and N bits (2 or 3) are added to the Nss field to indicate UEQM differential patterns, which is illustrated in FIG. 6. In this example, the MCS subfield indicates the MCS (M) of the 1st stream/RU, and the 4-bit Nss subfield indicates both Nss and UEQM pattern. Thus, the user info field shown in FIG. 6 includes an Nss and unequal modulation subfield. Below is one example of a 4-bit Nss and UEQM table.

| | Nss or UEQM pattern |
|---|---|
| 0000~0111 | EQM Nss = 1 to 8 |
| 1000 | 2ss UEQM with [M, M-1] |
| 1001 | 2ss UEQM with [M, M-2] |
| 1010 | 3ss UEQM with [M, M, M-1] |
| 1011 | 3ss UEQM with [M, M, M-2] |
| 1100 | 3ss UEQM with [M, M-1, M-2] |
| 1101 | 4ss UEQM with [M, M, M-1, M-1] |
| 1110 | 4ss UEQM with [M, M, M-1, M-2] |
| 1111 | 4ss UEQM with [M, M-1, M-2, M-2] |

In an embodiment, the reserved bit may be skipped or removed to make the total bit count to be twenty-two (22) for the user info field.

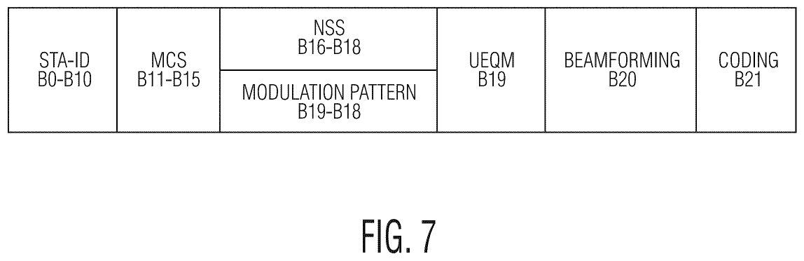

The second option of the first method using a 22-23 bit user info field is further described using four examples. In this second option, the user info field is the same size as EHT (22 bits) or one reserved bit is added. In a first example, a single bit UEQM subfield indicates different interpretation of the Nss subfield, as illustrated in FIG. 7. If the UEQM subfield (B19) indicates EQM, B16-B18 indicate the total number of streams (1˜8). If the UEQM subfield (B19) indicates UEQM, B16-B18 indicate the UEQM pattern for Nss. In this scenario, the beamforming bit (B20) and the coding bit (B21) may be reserved if B19 indicates UEQM. Below is one example of a modulation pattern table.

| | Nss and Modulation |
|---|---|
| B16-B18 | pattern |
| 000 | [M, M-1] |
| 001 | [M, M-2] |
| 010 | [M, M, M-1] |
| 011 | [M, M, M-2] |
| 100 | [M, M-1, M-2] |
| 101 | [M, M, M, M-1] |
| 110 | [M, M, M, M-2] |
| 111 | [M, M, M-1, M-2] |

In this example, as shown in FIG. 7, the location of the bits in the user info field are merely illustrative. The location of the bits may vary from the illustrated example. In addition, one “Reserved” bit may be added. As noted above, the beamforming and coding subfields may be reserved for the UEQM mode.

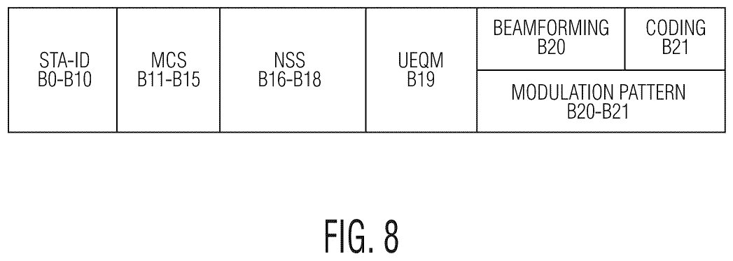

In a second example, a single bit UEQM subfield indicates different interpretation of the beamforming and coding subfields, as illustrated in FIG. 8. In this example, the user info field includes a 5-bit MCS subfield, a 3-bit Nss subfield and a 1-bit UEQM subfield. If the UEQM bit indicates EQM, B20-B21 indicate the beamforming bit (B21) and the coding bit (B22). If the UEQM bit indicates UEQM, B20-B21 indicate the UEQM pattern for the Nss indicated by the Nss subfield. In an embodiment, B18 or entries for Nss greater than four (4) (“Nss>4”) may be reserved for the UEQM mode. Below is one example of a modulation pattern table.

| | Nss = 2 | Nss = 3 | Nss = 4 |
|---|---|---|---|
| 00 | [M, M-1] | [M, M, M-1] | [M, M, M, M-1] |
| 01 | [M, M-2] | [M, M, M-2] | [M, M, M, M-2] |
| 10 | Reserved | [M, M-1, M-2] | [M, M, M-1, M-2] |
| 11 | Reserved | Reserved | Reserved |

In this example, as shown in FIG. 8, the location of the bits in the user info field are merely illustrative. The location of the bits may vary from the illustrated example. In addition, one “Reserved” bit may be added. As noted above, if the UEQM subfield (B16) indicates UEQM, B18 or the Nss entries related to Nss>4 can be reserved.

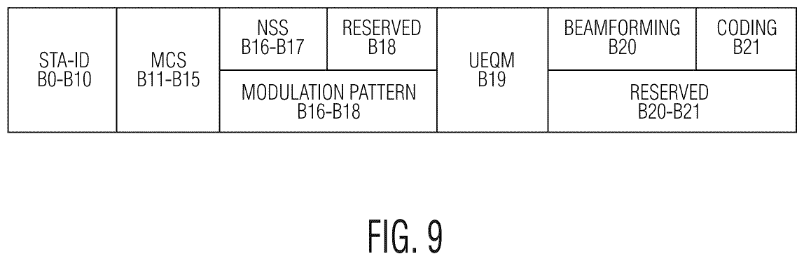

In a third example, the user info field is similar to the first example, but the Nss field is limited to two (2) bits for single user, as illustrated in FIG. 9. If the UEQM subfield (B19) indicates EQM, B16-B17 indicate the total number of streams (1˜4). In this scenario, B18 is reserved or used for signaling of other features, like 2×1944 code. If the UEQM subfield (B19) indicates UEQM in spatial domain, B16-B18 indicate the UEQM pattern for Nss. In this scenario, the beamforming bit (B20) and the coding bit (B21) may be reserved or redefined for other features, e.g., 1 bit for 2×1944 code and/or 1 bit for frequency domain.

In this example, as shown in FIG. 9, the location of the bits in the user info field are merely illustrative. The location of the bits may vary from the illustrated example. In addition, one “Reserved” bit may be added to make the total bit count to be twenty-three (23) for the user info field.

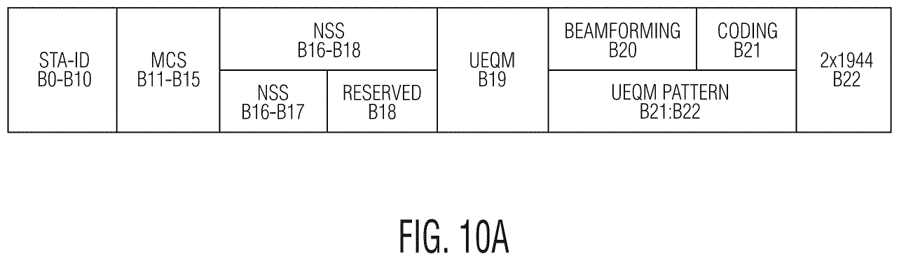

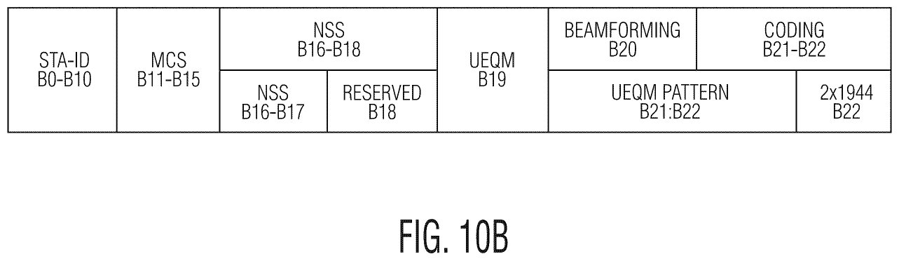

In an embodiment, by increasing one bit in the 23-bit user info, the signaling can be streamlined to indicate all the features. In a first option, a single bit UEQM subfield indicates different interpretation of the beamforming and coding subfields, as illustrated in FIG. 10A. In this example, the user info field includes a 5-bit MCS subfield, a 3-bit Nss subfield and a 1-bit UEQM subfield. If the UEQM bit indicates EQM, B20-B21 indicate the beamforming bit (B21) and the coding bit (B22). If the UEQM bit indicates UEQM, B20-B21 indicate the UEQM pattern for the Nss indicated by the Nss subfield. In an embodiment, B18 or entries for Nss greater than four (4) (“Nss>4”) may be reserved for the UEQM mode. One additional coding bit 2×1944 Code may be added, as illustrated in FIG. 10A. The coding bit and 2×1944 bit can be combined to a 2-bit subfield to indicate coding settings for EQM, which can indicate at least the options of “binary convolutional code” (BCC), “low-density parity-check” (LDPC) and “2×1944”, as illustrated in FIG. 10B.

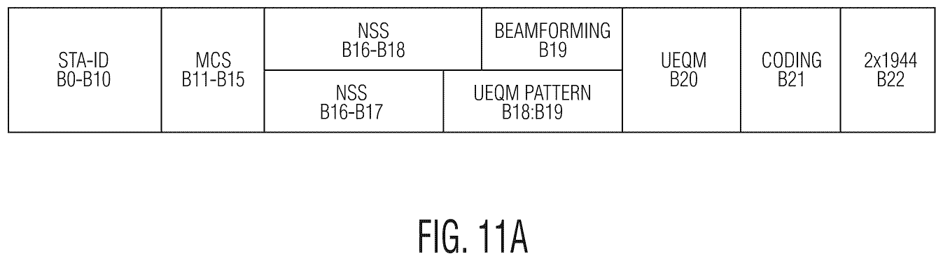

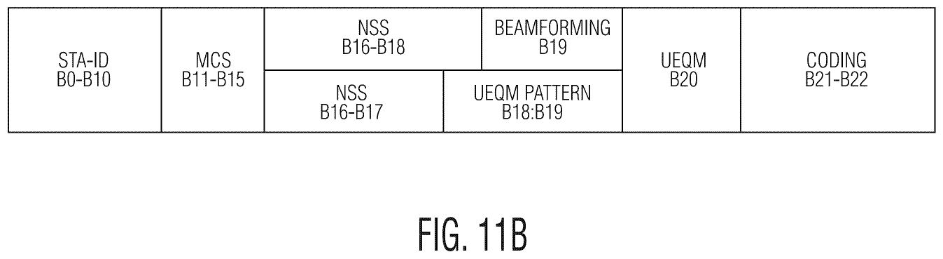

In a second option, one UEQM bit indicates UEQM pattern signaling of 2-bits. If EQM, the two bits indicate beamforming and the most significant bit (MSB) of Nss. If UEQM, the two bits indicate the UEQM pattern, as illustrated in FIG. 11A. The coding bit and 2×1944 bit can be combined to a 2-bit subfield to indicate coding settings for EQM, as illustrated in FIG. 11B. For UEQM, “BCC” and “LDPC” entries are reserved.

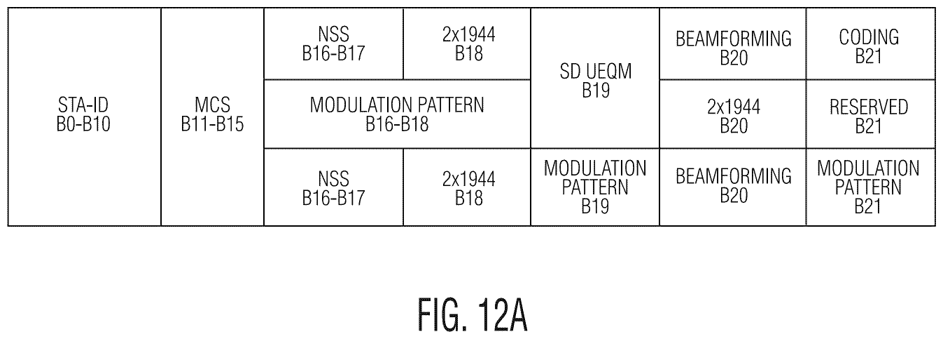

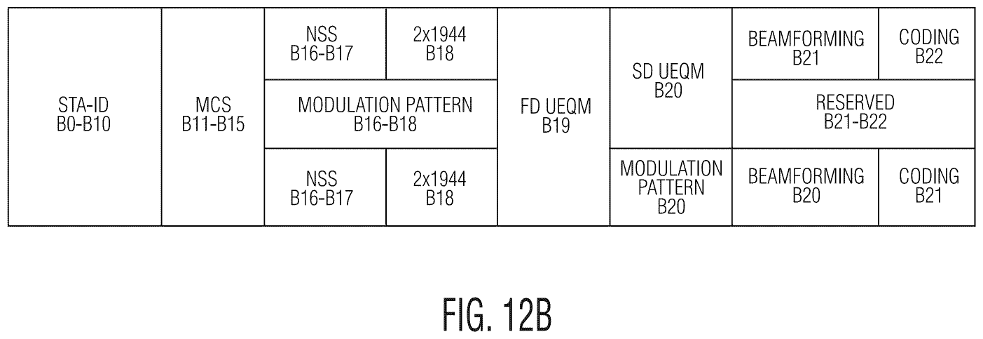

The following are examples of “FD UEQM” indicated in a common info field in accordance with embodiments of the invention. In a first example, which is illustrated in FIG. 12A, the FD UEQM is indicated using a spatial domain (SD) UEQM subfield (B19). In this example, B19 is also used for modulation pattern, which results in a 22-bit user info field. In a second example, which is illustrated in FIG. 12B, FD UEQM is indicated using an FD UEQM subfield (B19). In this example, B19 is used exclusively to indicate FD UEQM, which results in a 23-bit user info field.

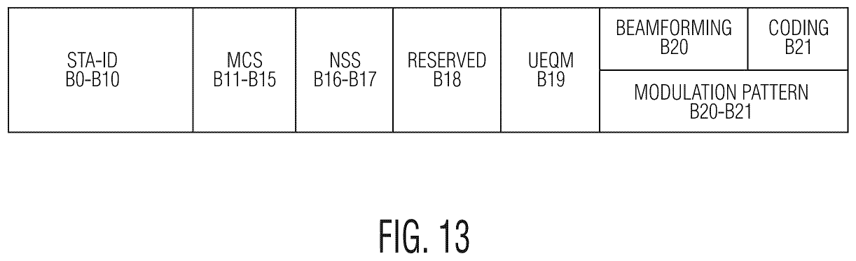

In a fourth example of the second option of the first method using a 22-23 bit user info field, a single bit UEQM subfield indicates different interpretation of the beamforming and coding subfields, which is illustrated in FIG. 13. This fourth example is similar to the second example except that the Nss subfield is a 2-bit field. Thus, in this fourth example, the user info field includes a 5-bit MCS subfield, a 2-bit Nss subfield and a 1-bit UEQM subfield. In this example, if the UEQM bit indicates EQM, B20-B21 indicate the beamforming bit (B21) and the coding bit (B22). If the UEQM bit indicates UEQM, B20-B21 indicate the UEQM pattern for the Nss indicated by the Nss subfield. The 2-bit Nss subfield indicates 1 to 4 Nss for single user. B18 is reserved, or used for other signaling, for example, indicating the use of the 2×1944 code format.

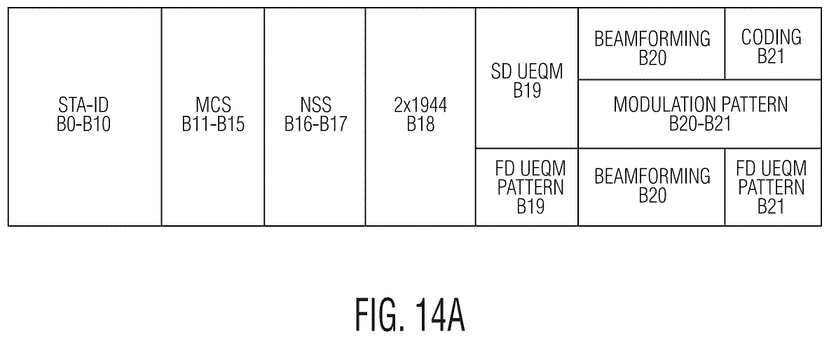

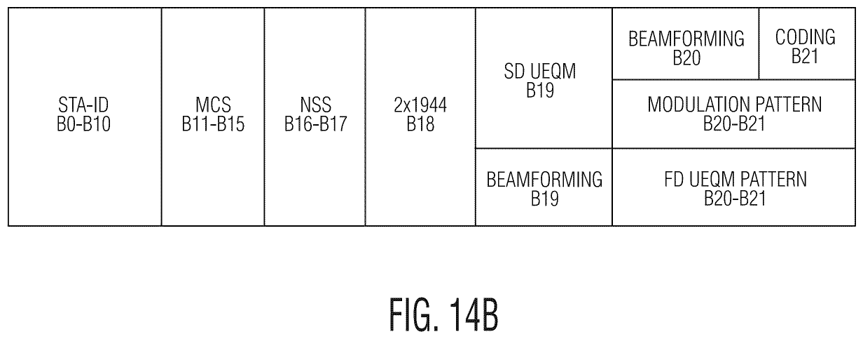

The following are examples of “FD UEQM” indicated in a common info of a 22-bit user info field in accordance with embodiments of the invention. In a first example, which is illustrated in FIG. 14A, the FD UEQM is indicated using B19 (an SD UEQM subfield), which is used to indicate SD UEQM. B19 is also used for an FD UEQM pattern. In a second example, which is illustrated in FIG. 14B, the FD UEQM is indicated using B19 (an SD UEQM subfield), which is used to indicate SD UEQM. B19 is also used for beamforming.

In the second method, the MCS table indicates mixed EQM and UEQM. There are two options for the second method. The first option uses a new 1-bit MCS indication and a 4-bt MCS subfield. In this first option, if the new MCS bit is 0, the MCS subfield indicates the table for existing sixteen (16) equal MCS. If the new MCS bit is 1, the MCS subfield indicates the table for new EQM MCS and UEQM. For UEQM, the meaning of the entry differs for different Nss.

In a second option, 4+N bits signal all 2\hat{ }(N+4) options for mixed EQM and UEQM with the first sixteen (16) options the same as the existing 4-bit MCS subfield. From index 17, it indicates the new EQM and UEQMs. For UEQM, the meaning of the entry differs for different Nss. In an alternative second option, the 4+N bits jointly signal MCS and Nss, similar to the 11n MCS/Nss table. That is, the first segment of the entries is for 1ss EQM, the second segment of the entries is for 2ss EQM, the third segment of the entries is for 2ss UEQM, etc. For either case, the N bits can be (1) newly defined bits if UHR user info field has new format with more bits, or repurposed from EHT user info field if UHR user info field reuses the same size as EHT. The potential repurposed fields may be: non-trigger based PPDU signal field (non-TB PPDU SIG) (coding bit (1 bit), Nss (2 bits), reserved bit (1-bit)) or Trigger frame (coding bit (1-bit), spatial stream (SS) allocation (2 bits), association identifier (AID) (1 bit), reserved bit (1-bit)). Below is a table for 4+N bits, where N=2.

| 6-bit | Nss = 1 | Nss = 2 | Nss = 3 | Nss = 4 |
|---|---|---|---|---|
| 0~15 | EQM MCS0~15 | | | |
| 16~18 | New EQM MCS 16~18 | | | |
| 19 | Reserved | [16QAM, | [16QAM, QPSK, | [16QAM, 16QAM, QPSK, |
| | | QPSK], ½ | QPSK] ½ | QPSK] ½ |
| 20 | | [64QAM, QPSK] | [64QAM, 16QAM, | [64QAM, 64QAM, QPSK, |
| | | ½ | QPSK] ⅔ | QPSK] ⅔ |
| 21 | | [64QAM, | [64QAM, 16QAM, | [64QAM, 16QAM, 16QAM, |
| | | 16QAM] ⅔ | 16QAM] ⅔ | QPSK] ⅔ |
| . . . | | . . . | . . . | . . . |
| 31 | | [1024QAM, | [1024QAM, | [1024QAM, 1024QAM, |
| | | 64QAM] ⅔ | 1024QAM, 64QAM], | 64QAM, 16QAM], ¾ |
| | | | ¾ | |
| . . . | | . . . | . . . | . . . |
| 63 | | [4096QAM, | [4096QAM, | [4096QAM, 4096QAM, |
| | | 1024QAM] ⅚ | 1024QAM, 256QAM] | 1024QAM, 256QAM] ⅚ |
| | | | ⅚ | |

Any of the MCS signaling methods described above may work for both non-TB PPDU SIG user info field or Trigger frame user info field. In addition, any of the new signal bits proposed above (e.g., the extra 1-bit MCS, 1-bit EQM/UEQM or N bits differential MCS/modulation, etc.) can be (1) new bits defined for UHR only if UHR user info field has a new format with more bits, or (2) repurposed from the EHT user info field if UHR user info field reuses the same size as EHT. The potential repurposed fields may be non-TB PPDU SIG (coding bit (1 bit), Nss (2 bits), reserved bit (1-bit)) and/or Trigger frame (coding bit (1-bit), SS allocation (2 bits), AID (1 bit), reserved bit (1-bit)).

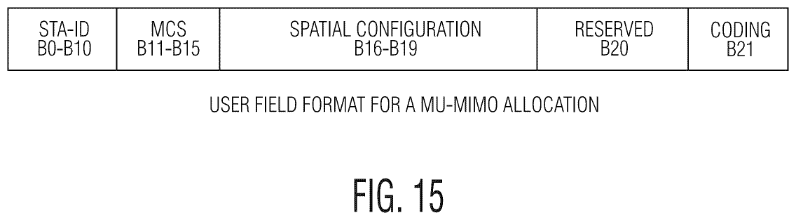

As unequal modulation across spatial domain is not defined for Multi-User Multiple-Input, Multiple-Output (MU-MIMO) allocation, only the new MCS needs signaling. In an embodiment, the spatial stream configuration subfield bits are shrunk or reduced from six (6) to four (4) (with up to Nss, tot=8), and five (5) bits are used to indicate the new MCS, as illustrated in FIG. 15, which shows a user info field for a MU-MIMO allocation in accordance with an embodiment of the invention. It is noted here that the reserved bit B20 may be used to signal another feature, e.g., 2×1944 or LDPC.

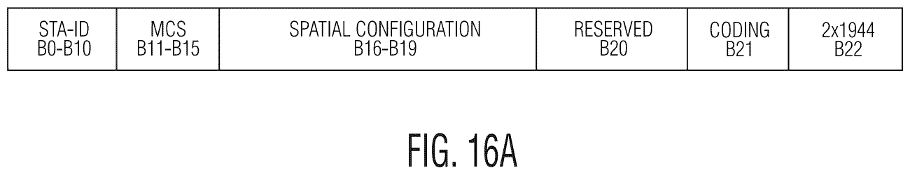

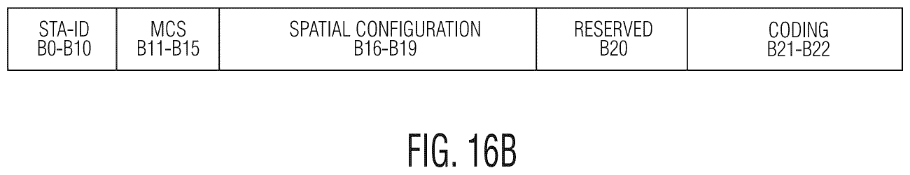

In an embodiment, one bit is added for 2×1944 indication to create a 23-bit user info field for a MU-MIMO allocation, as illustrated in FIG. 16A. In an alternative embodiment, the coding bit and 2×1944 bit may be combined as one subfield, as illustrated in FIG. 16B, which can indicate at least the options of “BCC”, “LDCP” and “2×1944”.

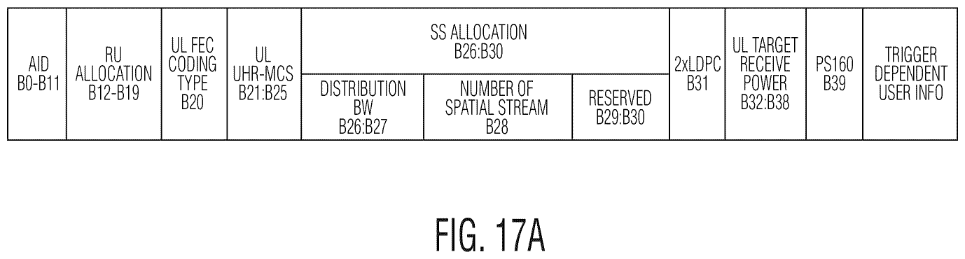

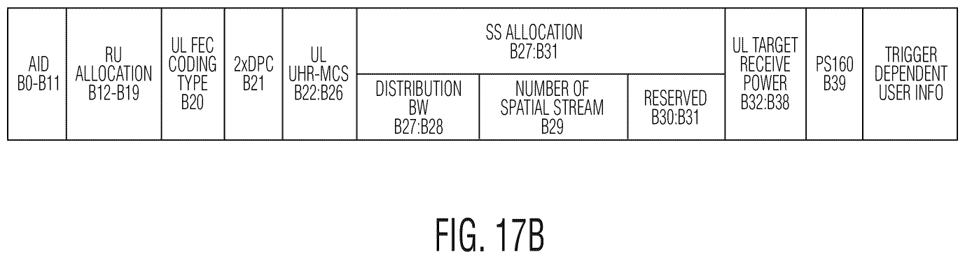

For an Uplink (UL) TB PPDU, a new trigger frame is needed to solicit UL Tx with new MCS. FIG. 17A shows a new trigger frame in accordance with an embodiment of the invention. As shown in FIG. 17A, the new trigger frame includes an AID field (B0-B11), an RU allocation field (B12-B19), an UL forward error correction (FEC) coding type field (B20), a UL UHR MCS field (B21-B25), an SS allocation field (B26-B30), a distribution bandwidth (BW) field (B26-B27), an Nss field (B28), a reserved field (B29-B30), a 2×LDPC field (B31), a UL target receive power field (B32-B38), a PS160 field (B39) and a trigger dependent user info field. FIG. 17B shows a new trigger frame in accordance with another embodiment of the invention, where the 2×LDPC field has been moved to a location between the UL FEC coding type field and the UL UHR MCS field.

As illustrated in FIGS. 10A, 16A and 17A, a 5-bit MCS subfield for UHR may be used in a non-MUMIMO user info field, a MUMIMO allocation and a trigger frame in accordance with embodiments of the invention. A 4-bit MCS table is designed up to 11be and all entries have been used. A new 5-bit table can be designed to utilize the legacy 4-bit MCS table.

In an embodiment, the 5-bit UHR MCS indexes are mapped in the manner shown in the following table.

| 5-bit UHR MCS Index | MCS: modulation and coding |
|---|---|
| 0-15 | EHT MCS 0-15 |
| 16 | QPSK, 2/3 code |
| 17 | 16QAM, 2/3 code |
| 18 | 16QAM, 5/6 code |
| 19 | 256QAM, 2/3 code |
| 20-31 | Reserved |

In an alternative embodiment, the five (5) bits of the MCS subfield are interpreted as fixed point U4.1. As such, B5:B1 with B0=0 indicates the MCS indexes of 0-15, which has the same mapping as EHT MCS indexes for 0-15. However, B5:B1 with B0=1 indicates additional decimal MCS indexes for new MCSs. The entire U4.1 MCS index indicates MCS with monotonically rate increase with wrap around from MCS14. The 5-bit MCS table for this embodiment is shown below.

| 5-bit UHR MCS | | | |
|---|---|---|---|
| Index (U4.1) | B5:B1 | B0 | MCS: modulation and coding |
| 0 | 0 | 0 | BPSK, 1/2 code (EHT MCS 0) |
| 0.5 | 0 | 1 | Reserved |
| 1 | 1 | 0 | QPSK, 1/2 code (EHT MCS 1) |
| 1.5 | 1 | 1 | QPSK, 2/3 code |
| 2 | 2 | 0 | QPSK, 3/4 (EHT MCS 2) |
| 2.5 | 2 | 1 | Reserved |
| 3 | 3 | 0 | 16QAM, 1/2 code (EHT MCS 3) |
| 3.5 | 3 | 1 | 16QAM, 2/3 code |
| 4 | 4 | 0 | 16QAM, 3/4 code (EHT MCS 4) |
| 4.5 | 4 | 1 | 16QAM, 5/6 code |
| 5 | 5 | 0 | 64QAM, 2/3 code (EHT MCS 5) |
| 5.5 | 5 | 1 | Reserved |
| 6 | 6 | 0 | 64QAM, 3/4 code (EHT MCS 6) |
| 6.5 | 6 | 1 | Reserved |
| 7 | 7 | 0 | 64QAM, 5/6 code (EHT MCS 7) |
| 7.5 | 7 | 1 | 256QAM, 2/3 code |
| 8 | 8 | 0 | 256QAM, 3/4 (EHT MCS 8) |
| 8.5 | 8 | 1 | Reserved |
| 9 | 9 | 0 | 256QAM, 5/6 (EHT MCS 9) |
| 9.5 | 9 | 1 | Reserved |
| 10 | 10 | 0 | 1024QAM, 3/4 (EHT MCS 10) |
| 10.5 | 10 | 1 | Reserved |
| 11 | 11 | 0 | 1024QAM, 5/6 (EHT MCS 11) |
| 11.5 | 11 | 1 | Reserved |
| 12 | 12 | 0 | 4096QAM, 3/4 (EHT MCS 12) |
| 12.5 | 12 | 1 | Reserved |
| 13 | 13 | 0 | 4096QAM, 5/6 code (EHT MCS 13) |
| 13.5 | 13 | 1 | Reserved |
| 14 | 14 | 0 | EHT MCS14 |
| 14.5 | 14 | 1 | Reserved |
| 15 | 15 | 0 | EHT MCS15 |
| 15.5 | 15 | 1 | Reserved |

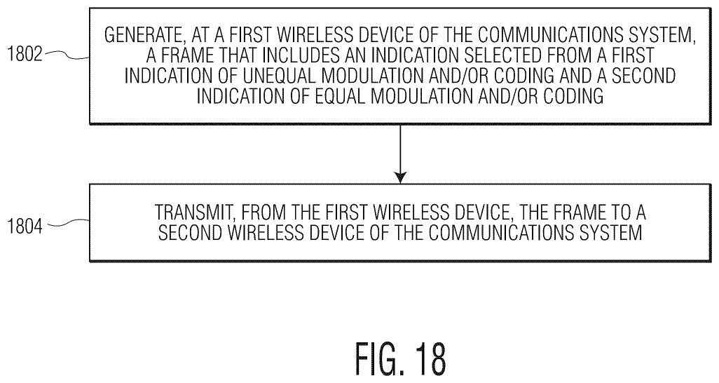

A method of transmitting a frame in a communications system in accordance with an embodiment of the invention is described with reference to a flow diagram of FIG. 18. At block 1802, a frame that includes an indication selected from a first indication of unequal modulation and/or coding and a second indication of equal modulation and/or coding is generated at a first wireless device of the communications system. At a block 1804, transmitting, from the first wireless device, the frame is transmitted to a second wireless device of the communications system from the first wireless device.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A wireless device comprising:
a wireless transceiver to receive and transmit frames; and
a controller operably coupled to the wireless transceiver to process the frames, wherein the controller is configured to generate a frame that includes an indication selected from a first indication of an unequal modulation and/or coding and a second indication of equal modulation and/or coding.

2. The wireless device of claim 1, wherein the controller is configured to generate the frame that includes a 1-bit unequal modulation subfield in a user info field of the frame.

3. The wireless device of claim 1, wherein the controller is configured to generate the frame, wherein an unequal modulation subfield of the frame indicates when an unequal modulation is used and a corresponding unequal modulation pattern is indicated in a modulation pattern subfield of the frame.

4. The wireless device of claim 1, wherein the controller is configured to generate the frame, wherein a beamforming bit and a coding bit are used to indicate an unequal modulation pattern when an unequal modulation is used.

5. The wireless device of claim 1, wherein the controller is configured to generate the frame, wherein a beamforming bit and a bit from a number of spatial streams subfield are used to indicate an unequal modulation pattern.

6. The wireless device of claim 1, wherein the controller is configured to generate the frame, wherein an indication of the unequal modulation pattern is dependent on the total number of spatial streams.

7. The wireless device of claim 1, wherein the controller is configured to generate the frame, wherein the unequal modulation pattern indicates a modulation order difference of each spatial stream from a first spatial stream.

8. The wireless device of claim 1, wherein the controller is configured to generate the frame that includes a 5-bit Modulation and Coding Scheme (MCS) subfield that signals all MCS options for all spatial streams when the equal modulation is indicated and for a first spatial stream when the unequal modulation is indicated.

9. The wireless device of claim 1, wherein the controller is configured to generate the frame that separately signals the unequal modulation and/or coding and the equal modulation and/or coding.

10. The wireless device of claim 9, wherein the controller is configured to generate the frame that includes an N-bit subfield that signals a pattern selected from a plurality of patterns, wherein the patterns include a particular pattern that indicates an equal Modulation and Coding Scheme (MCS) and differential modulation and/or MCS unequal modulation patterns.

11. The wireless device of claim 9, wherein the controller is configured to generate the frame that includes an unequal modulation subfield that indicates when an unequal modulation and/or an unequal Modulation and Coding Scheme (MCS) is used and an MCS subfield that indicates a pattern for a particular number of spatial streams.

12. The wireless device of claim 1, wherein the controller is configured to generate the frame that jointly signals the unequal modulation and/or coding and the equal modulation and/or coding.

13. The wireless device of claim 12, wherein the controller is configured to generate the frame that includes a 5-bit Modulation and Coding Scheme (MCS) subfield, wherein a bit in the MCS subfield indicates when an equal modulation or an unequal modulation and/or MCS is used, and wherein four bits of the MCS subfield indicate a pattern from a plurality of equal modulation, unequal modulation and/or unequal MCS patterns.

14. The wireless device of claim 12, wherein the controller is configured to generate the frame that includes (4+N) bits that indicate an equal modulation pattern and an unequal modulation and/or unequal MCS pattern, wherein N is a positive integer and wherein the unequal modulation and/or unequal MCS pattern corresponds to a particular number of spatial streams.

15. The wireless device of claim 12, wherein the controller is configured to generate the frame that includes (4+N) bits that indicate an equal modulation pattern, an unequal modulation and/or unequal MCS pattern and a number of spatial streams, wherein N is a positive integer.

16. The wireless device of claim 1, wherein the controller is configured to generate the frame, wherein a coding bit in the bit is repurposed to indicate an unequal modulation pattern over a frequency domain.

17. A method of transmitting a frame in a communications system, the method comprising:
generating, at a first wireless device of the communications system, a frame that includes an indication selected from a first indication of unequal modulation and/or coding and a second indication of equal modulation and/or coding; and
transmitting, from the first wireless device, the frame to a second wireless device of the communications system.

18. The method of claim 17, wherein the frame includes a 1-bit unequal modulation subfield in a user info field of the frame.

19. The method of claim 17, wherein an unequal modulation subfield of the frame indicates when an unequal modulation is used and a corresponding unequal modulation pattern is indicated in a modulation pattern subfield of the frame.

20. A wireless device comprising:
a wireless transceiver to receive and transmit frames; and
a controller operably coupled to the wireless transceiver to process the frames, wherein the controller is configured to generate a frame that includes an indication selected from a first indication of an unequal modulation and/or coding and a second indication of equal modulation and/or coding and wherein the frame includes a 5-bit Modulation and Coding Scheme (MCS) subfield and an N-bit unequal modulation subfield that signals a pattern of modulation or MCS difference relative to a base MCS.
